(19) United States
(12) Patent Application Publication
(10) Pub. No.: US 2006/0078861 A1
(43) Pub. Date: Apr. 13, 2006

(54) Children's storybook with music player

(76) Inventor: Julia Sabbagh, South Salem, NY (US)

Correspondence Address: Richard M. Rosati;KENYON & KENYON, One Broadway, New York, NY, 10004, US

(21) Appl. No.: 10/961,359

(22) Filed: Oct. 7, 2004

(51) Int. Cl. G09B 5/00

(52) U.S. Cl. 434/317

(57) ABSTRACT

A storybook including instructions at various points in a given story as to which disk or tape associated with the storybook to load in the player and play. The various music selections for each story may be associated with a single disk, and therefore, upon turning to a new story the reader is instructed to load a different disk including various music selections associated with the new story. Throughout the story directions are provided as to which specific track or song associated with the loaded disk to play.

### FIELD OF THE INVENTION

The invention relates to a book. More particularly, the invention relates to a music player storybook for children.

### BACKGROUND OF THE INVENTION

A children's songbook, sold under the Reader's Digest trademark My Play CD Book, including a digital music player which plays musical notes printed in the book is known. The music player and associated disks are attached to an overhang portion of the back cover of the book. Each disk is used to play a single song and instructions are provided in the book before each song to insert the disk into the player and press a play button. Each disk has a projecting pin which depresses a button in the player when the disk is loaded in the player. Upon depression of a play button on the player, the player plays a single song associated in its internal memory with the button depressed by the pin projecting from the disk loaded in the player. The pin on each disk is in a different position such that each disk depresses a different button in the player when loaded and, thus, causes the player to play a different song upon depression of the play button.

While the My Play CD Book has been successful in enhancing and facilitating children's appreciation and learning of music a need still exists for a children's storybook, which draws the reader into the story by providing for acoustic accompaniment, such as music.

### SUMMARY OF THE INVENTION

Accordingly, it is an object of the invention to produce a children's storybook including a front, back, binder and a music player. In one example embodiment of the storybook of the present invention, the book includes directions at various points in a given story as to which disk or tape to load in the player and play. The various music selections for each story may be associated with a single disk, and therefore, upon turning to a new story the reader is instructed to load a different disk associated with various music selections relating to the new story. Throughout the story directions are provided as to which specific acoustic accompaniment, e.g., track or song, associated with the loaded disk to play. Each disk may actually contain music and be read by the music player or may simply act as a key or address so as to allow access to a section of internal memory of the music player associated with a given disk.

In an exemplary embodiment the book may include an overhang portion used to support a music player and various disks or tapes, etc. Alternatively, a cut-out may be provided in one or more of the pages and the music player and disks may be connected to the back cover or one of the pages through the cut-out.

The book of the present invention is not limited to a storybook and the player is not limited to playing music. Rather the book may comprise any type of book, the reading of which may be enhanced by an acoustic accompaniment, and the player may provide any type of acoustic accompaniment, including sounds other than music, such as voice. For example, the book may comprise a non-fiction interactive reference book and the player may play answers to questions, nature sounds, etc. Also, the voice may read answers to questions found in the book or additional information regarding the subject matter.

Various information for each story may be associated with a single disk and therefore turning to a new section of the book the reader may be instructed to load a different disk with new information associated with the book.

A book according to an exemplary embodiment of the invention includes directions at multiple predetermined locations directing a reader to play at least a portion of data stored in a player. The player may be configured to play stored data upon loading of a disk and activation by a user. The player and stored data may be configured such that activation of the player plays one block of the stored data associated with the loaded disk and relevant to a portion of the book and activation of the player a subsequent time plays another block of the stored data associated with the loaded disk and relevant to another portion of the book. The player may be configured to automatically stop playing at the end of each block of the stored data.

In an exemplary embodiment of the invention, the book may include a front cover, a back cover, a binder portion connecting the front and back covers, and at least one page between the front and back covers, the at least one page including the directions.

In an exemplary embodiment of the invention, the book may include a story including a direction indicating when to load one of the one or more disks associated with the story into the player and one or more directions at various points in the story indicating when to activate the player so as to play blocks of stored data relating to specific portions of the story.

In an exemplary embodiment of the invention, each block of stored data may correspond to a musical piece.

In an exemplary embodiment of the invention, the player may include a memory unit including the stored data and the stored data may include sets of blocks, each of the one or more disks being associated with a different set.

In an exemplary embodiment of the invention, each disk may be configured to provide address information to the player for a different set of blocks. The player may be configured to play the first block in a given set upon a first activation of the player and one additional block in the set for each subsequent activation.

In an exemplary embodiment of the invention, the player may include a play button configured to activate the player and trigger the playing of the stored data. The player may also include a stop button for stopping the player.

In an exemplary embodiment of the invention, the player may include a retractable handle and may be configured to be removably connectable to the book, for example, on an overhang portion of the back cover.

In an exemplary embodiment of the invention, the book may include a bracket for removably fastening the player on the book via a sliding action of the bracket arms into recesses on a back surface of the player.

In an exemplary embodiment of the invention, the player may include a cover biased in an open state, a latch for retaining the cover in a closed state, and an open button for releasing the latch.

In an exemplary embodiment of the invention, the player may include a loading surface and may be configured such that a disk loaded in the player faces the loading surface. The loading surface may include one or more buttons or raised rings configured to mate with one or more recesses, protrusions or raised rings on a surface of the loaded disk facing the loading surface.

In an exemplary embodiment of the invention, the player may be configured such that one or more of the buttons in the loading surface are depressed by the loaded disk.

In an exemplary embodiment of the invention, the player may be configured such that one or more of the buttons in the loading surface fits into the one or more recesses in the loaded disk and are not depressed by said loaded disk.

In an exemplary embodiment of the invention, the player may be configured such that one or more buttons in the loading surface are depressed by one or more raised rings projecting from a surface of a loaded disk facing the player.

In an exemplary embodiment of the invention, the player may include a play button configured to activate the player and trigger the playing of the stored data and wherein upon depression of the play button the player determines which set of blocks to access based on which buttons on the loading surface are or are not depressed. Each set may be associated with at least one of a different story in the book and indicia on a different disk.

In an exemplary embodiment of the invention, each of the one or more disks may include indicia associated with the story in which the directions directing the reader to activate the player are included.

In an exemplary embodiment of the invention, the book may include a disk storage unit connected to the book, for example, the overhang portion, for storage of the one or more disks.

In an exemplary embodiment of the invention, the player may be configured to be removably connected to the book.

In an exemplary embodiment of the invention, the book includes a front cover, back cover, a binder portion connecting the front and back covers, and at least one page including at least one story between the front and back covers. The back cover includes an overhang portion which extends beyond an edge of the front cover and supports a player, which is configured to play stored data upon activation by a user. The at least one story includes one or more directions at various points in the at least one story indicating when to activate the player so as to play blocks of stored data associated with specific portions of the at least one story.

In an exemplary embodiment of the invention, the stored data may comprise sets of blocks of the stored data, each set being associated with a different story in the book. The stored data may include blocks and the player may be configured to automatically stop playing at the end of each block.

In an exemplary embodiment of the invention, the overhang portion may further support one or more disks for loading into the player.

In an exemplary embodiment of the invention, the at least one story may include directions indicating which of the one or more disks to insert into the player and when to make this insertion.

In an exemplary embodiment of the invention, the player may include an identification means for identifying which set of blocks of the stored data to access upon activation of the player.

In an exemplary embodiment of the invention, the book may not include the cover and/or intermediate pages. In which case, the entire story may be included on the back cover.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a top view of an exemplary embodiment of a music player book of the present invention in a closed state.

FIG. 1A is the book of FIG. 1 shown with the music player removed.

FIG. 1B is a perspective view of a bottom of the music player and its mounting bracket.

FIG. 1C is a top view of an exemplary embodiment of the music player book of the present invention without an overhang portion.

FIG. 2A is a top view of the music player with the handle in an open state.

FIG. 2B is a perspective view of an exemplary embodiment of the music player with the cover open and a music disk having recesses in place for insertion.

FIG. 2C is a perspective view of an exemplary embodiment of the music player with the cover open and a music disk having a circular ridge in place for insertion.

FIG. 3 is a perspective view of the book of FIG. 1 in an opened state.

### DETAILED DESCRIPTION

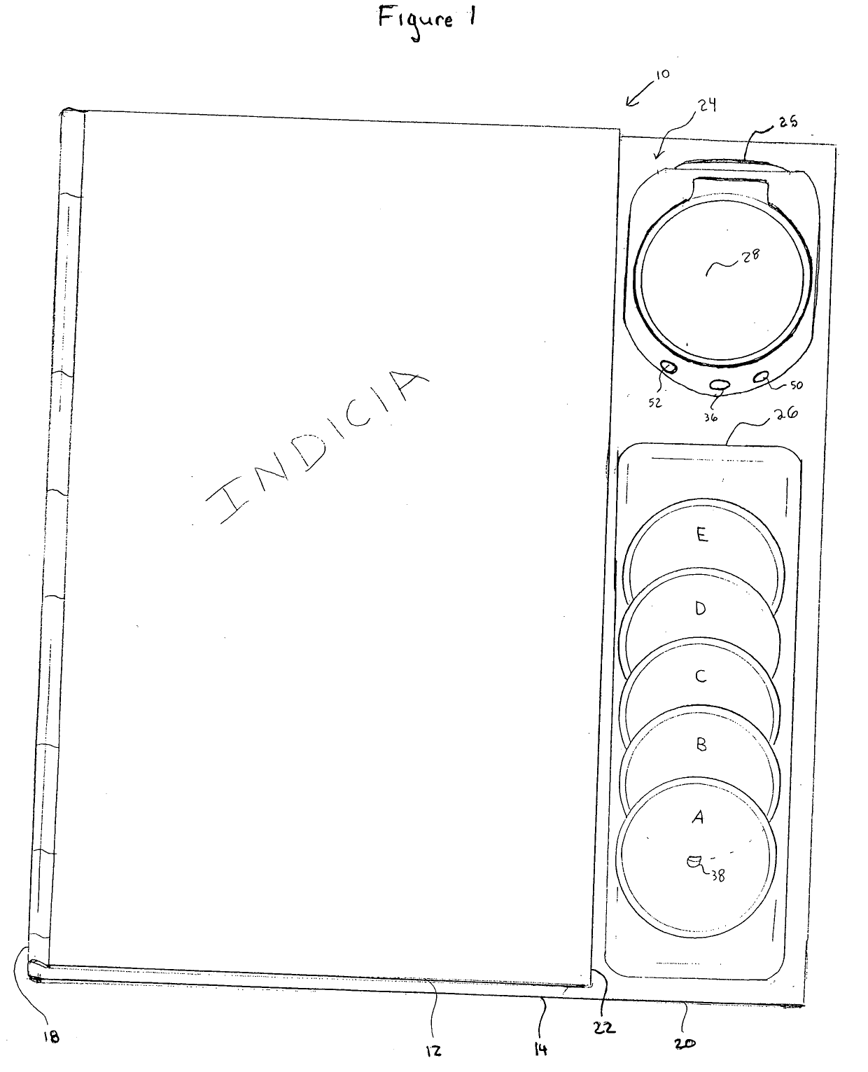

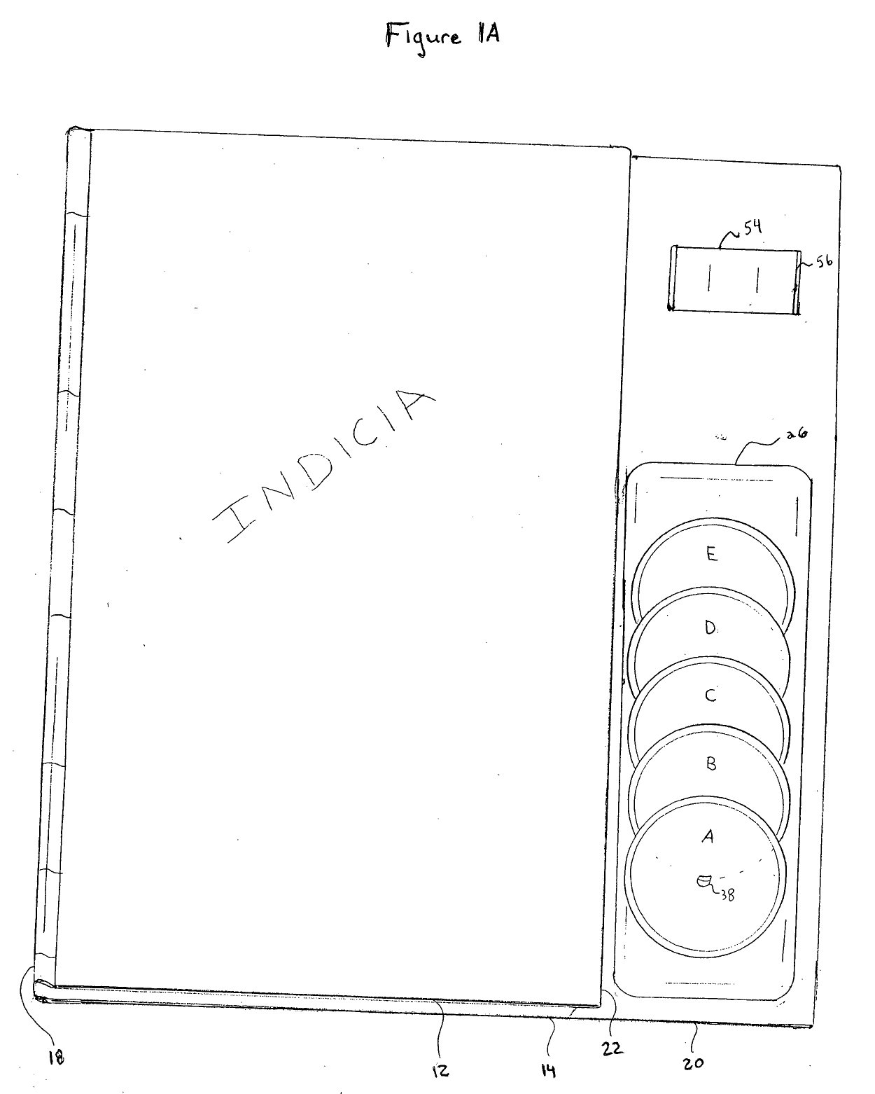

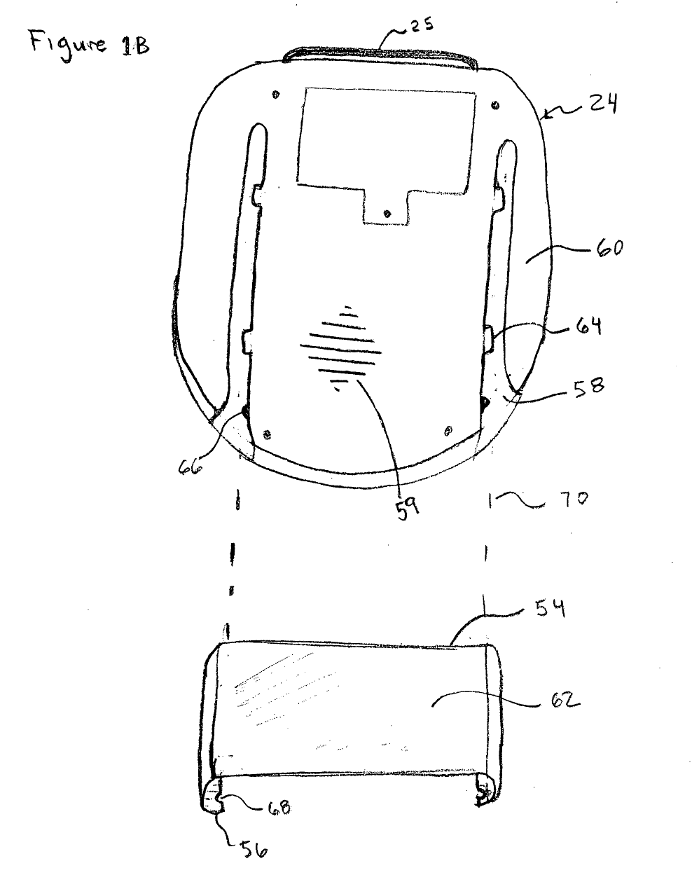

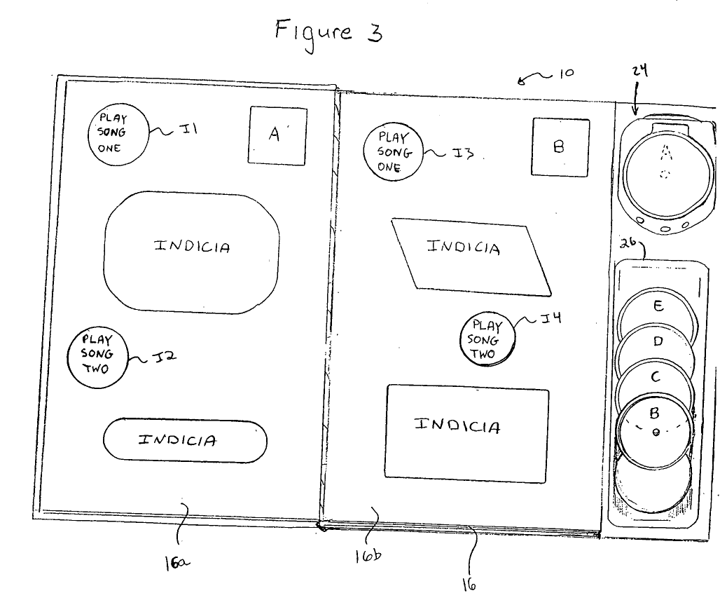

FIG. 1 illustrates a top view of an exemplary embodiment of a book 10 of the present invention comprising a cover 12, a back 14, pages 16 (FIG. 3), between cover 12 and back 14, and a binding portion 18, which connects the cover 12, back 14 and pages 16 together to form book 10. The cover 12 and back 14 may be made from separate boards connected by a separate binding portion 18 or may comprise a single folded board, wherein the fold itself comprises the binding portion 18. The back 14 includes an overhang portion 20, which extends beyond an edge 22 of cover 12, and supports a player 24 and a storage unit 26.

Alternatively, the player 24 and/or storage unit 26 may be supported by one of the cover 12, pages 16 or the back cover 12. In an exemplary embodiment, as illustrated in FIG 1C, the back 14 does not have an overhang portion and the player 24 is supported on a corner portion of the back 14 through a cut-out 17 in the pages 16.

In another exemplary embodiment of the present invention, the player 24 and/or storage unit 26 may be independent units that do not attach to the book 10.

In yet another alternative embodiment, the book may not include the cover and/or intermediate pages. In which case, the entire story may be included on the back cover.

In the present exemplary embodiment of the invention, the player includes a microcomputer or processor with memory and a speaker 59 (FIG. 1B). However, the player 24 may comprise any known device for emitting stored sound, for example, a compact disk player, DVD, tape player, etc.

Player 24 includes a retractable handle 25 and may be removably mounted to overhang portion 20 via bracket 54. FIG. 1A shows the book 10 with the player 24 removed exposing the bracket 54, which is fastened to the book 10 on a lower surface 62. As illustrated in FIG. 1B, bracket 54 includes arms 56 on both sides, which slide along lines 70 into recesses 58 on a back surface 60 of player 24. Tabs 64 secure arms 56 in a vertical direction within recesses 58 and ridges 66 mate with recesses 68 to provide resistance to sliding of arms 56 out of recesses 68 along lines 70.

The storage unit 26 stores, for example, disks A-E, which are stored in an overlapping manner. Storage unit 26 may be configured to store more or less disks. A lower portion of disk B is concealed behind an upper portion of disk A and, therefore, is shown in ghost lines. Both the cover 12, pages 16, binding portion 18 and back 14 may have indicia thereon.

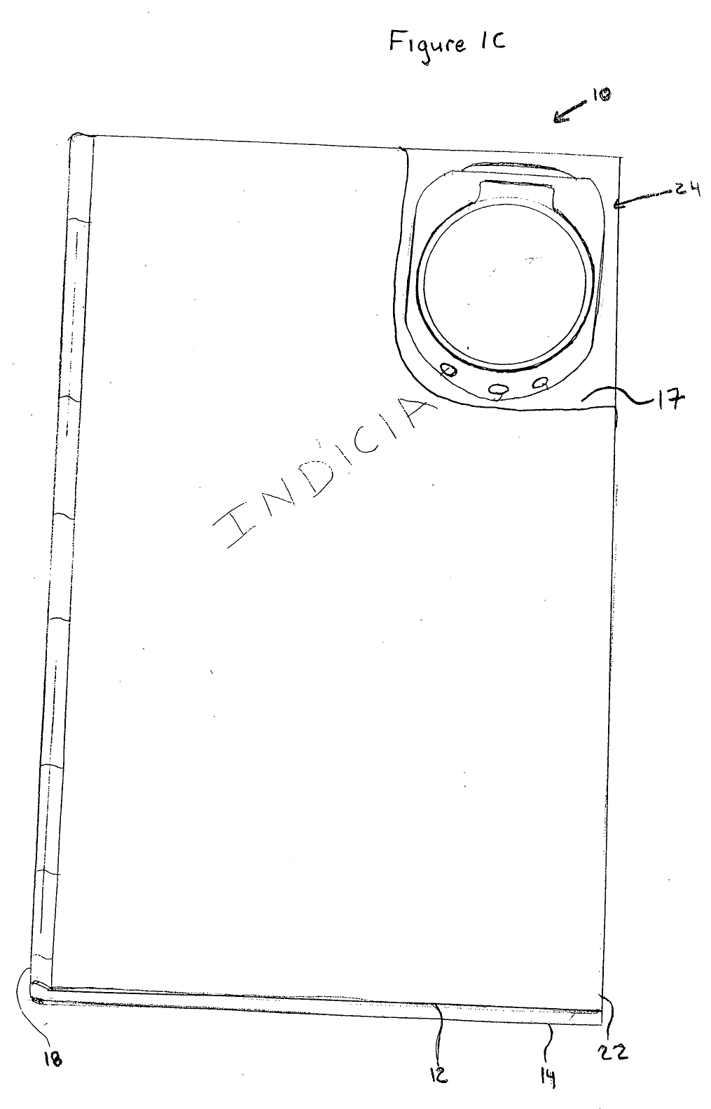

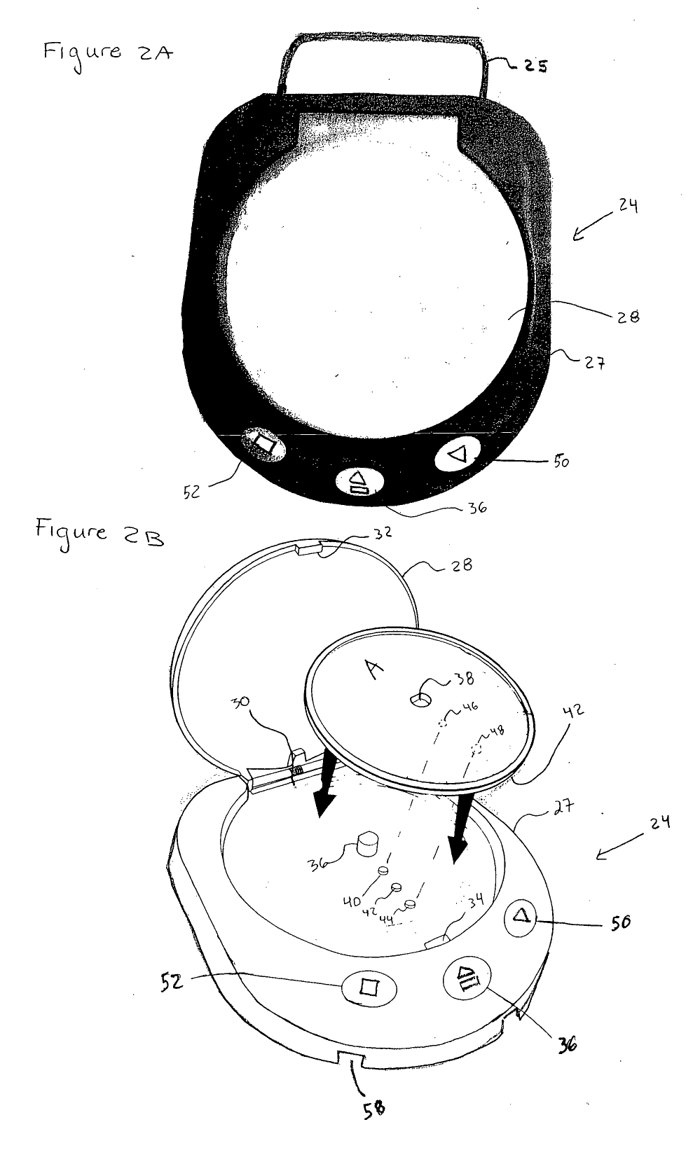

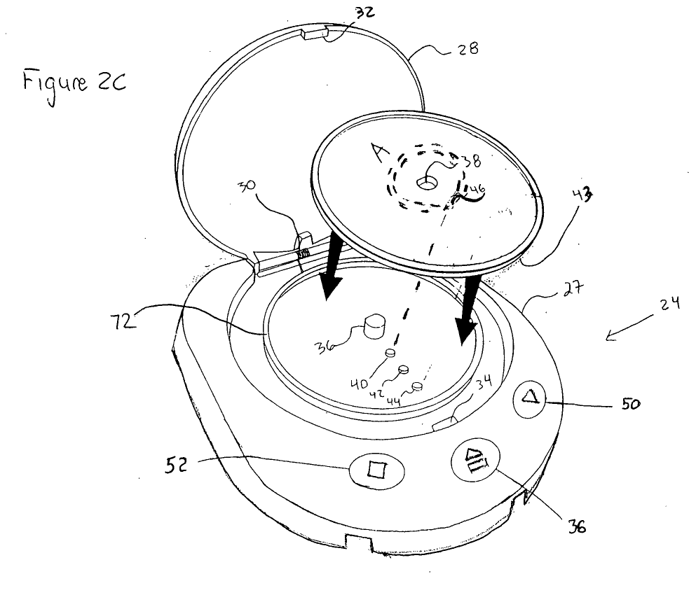

FIG. 2A is a top view of an exemplary embodiment of the player of the present invention, generally labeled 24, and FIG. 2B is a perspective view of the player 24 in an opened state. The player 24 includes a frame 27 and a cover 28, pivotally connected to the frame 27 and biased in the opened state via a spring 30. The cover 28 includes a projecting latch 32, which fits into recess 34 in frame 27 for locking cover 28 to frame 27. The handle 25, which slides into recesses in the player 10 (not shown), is shown in a fully open state. Button 36 may be used to open cover 28. Disk A is shown directly above player 24 in a position ready for loading into player 24. Disk A is loaded into player 24 by moving the disk in the direction of the arrows such that post 36 fits into a recess 38 in disk A.

FIG. 3 is a perspective view of the book 10 in an opened state revealing pages 16a and 16b. Page 16a may include, for example, a story, or any other text for that matter, in which case the indicia, labeled A, may correspond to a title of the story or other indicia and boxes labeled INDICIA may include the actual text of the story or other indicia. A story may include text alone, both text and illustrations or photographs or only illustrations or photographs. Disk A, which may include indicia indicating a connection or association to story A, is loaded in player 24 (label A is shown in ghost lines). Story A may include directions, also labeled A, as to which disk to load in the player 24, or directions, labeled I1 and I2, instructing the reader when to operate the player 24, i.e., press play button 50, to play, for example a background song to be listened to while reading the text of the story, etc. The instructions, I1 and I2, may be placed on page 16a at relevant points in the story during which the song or other acoustic accompaniment has special relevance to the story. Similarly upon beginning page 16b, a reader is instructed, per indicia labeled B, to load disk B into player 24. While reading indicia on page 16b, such as a story, instructions I3 and I4 indicate when to press button 50 so as to play a song or other acoustic accompaniment, which goes along with the indicia on page 16b. Stop button 52 may be depressed to stop the player 24. The player 24 automatically stops at the end of a given song or track associated with a given disk and only plays the next song or track upon a subsequent depression of the play button 50.

In an exemplary embodiment of the player 24, disks A-E may store data or information, e.g., accompanying music for a given story on pages 16, that is read by the player 24. A standard CD-player may be used, for example, however, given the sensitivity of compact disks to scratches such a device may not be the most practical for use with a children's book.

In another embodiment, the player 24 may include a means for identifying the disk loaded in the player 24, such as a set of disk identification buttons 40, 42 and 44 adjacent the post 36. Rather than actually reading information from disk A, the player 24 plays information, e.g., accompanying music for a given story, from its own internal memory, the selection of the group or set of songs accessed determined by the choice of disks loaded into the player 24. Given that the disks A-E are not used to actually store, for example, music, they can be made from a durable “childproof” plastic. Further, disks A-E may have other shapes, e.g., square, and sizes, so long as they can fit in the player 24.

Each of disks A-E have a different identification surface 43 used to identify the stored subset of data in the memory of player 24, e.g., accompanying music for a given title, to be played. For example, disk A, has an identification surface 43 which, upon loading of disk A in player 24 and depression of play button 50, triggers the playing by player 24 of a first block of stored data associated with disk A in the internal memory of the player 24, for example, accompanying music to a specific part of story A. Disk A has two recesses 46 and 48 on surface 43, shown in ghost lines, which mate with buttons 40 and 44. When disk A is loaded in player 24 and cover 28 is closed, buttons 40 and 44 fit in recesses 46 and 48, respectively, and, therefore, are not depressed, and button 42 is depressed by disk A. The microcomputer in the player 24 is programmed to play, for example, the first track of music associated with story A stored in its internal memory, when the cover 28 is closed over disk A, depressing only button 42, and upon depression by a user of play button 50. The internal memory of the player 24 may include sets of blocks, each set being associated with a different disk and each block including a different track or song. Each depression of the play button 50 causes the players to play the next block of data associated with set A in its internal memory. The player 24 stops automatically at the end of each block.

Disk B, for example, may include a single recess, which mates with button 42 upon loading of disk B into player 24. When disk B is loaded in player 24 and cover 28 is closed, button 42 fits into recess 52 and buttons 40 and 44 are depressed by disk B. The microcomputer in the player 24 is programmed to play a first block of stored data associated with disk B, e.g., a first track of accompanying music for story B on page 16b of book 10, when buttons 40 and 44 are depressed via loaded disk B and upon depression by a user of play button 50. Each subsequent depression of the play button 50 plays the next block of data associated with set B in the internal memory of the player 24.

Each disk A-E has a unique arrangement of recesses, each arrangement addressing a specific subset of internal memory of the player 24 associated with a given disk. Each subset of memory being further broken down into blocks such that each depression of button 50 causes the player 24 to play the next block stored in memory within the subset associated with a given disk. The player 24 may be;configured such that after depression of the stop button 52 depression of the play button 50 plays from the beginning the block that was previously stopped or plays the first block in the subset.

In an exemplary embodiment of the present invention, rather than recesses, surface 43 of the disks may be provided with circular ridges that interact with the buttons 40, 42 and 44 upon loading of the disk into the player 24. FIG. 2C illustrates the disk having a circular ridge projecting from the identification surface 43 of the disk (shown in ghost lines) which depresses button 40 upon loading of the disk into player 24. Disk B, for example, may be provided with a ridge or groove having a larger radius such that it depresses, for example, button 42 upon loading into player 24. Player 24 also includes a ring 72, which projects towards the disks and which supports the loaded disk directly above buttons 40, 42 and 44 such that unless the disk is provided with a projecting ridge buttons 40, 42 and 44 are not depressed by the disk. In an exemplary embodiment of player 24 without ring 72, the disks may be provided with circular grooves, as opposed to ridges, for selective non-depression of buttons 40, 42 and 44.

Alternatively, each disk may have one or more projecting pins which depress one or more buttons in the player 24 when the disk is loaded. Upon depression of the play button 50, the player 24 accesses a subset of internal memory associated with the button or combination of buttons depressed by the one or more pins on the loaded disk.

In an alternative embodiment, the identification means may comprise a tag on the disk that is electronically, optically and/or magnetically read by a reader in the player 24. The tag may include address data (similar to the address data represented by the depression of the buttons 40, 42 and 44) for accessing data stored in the internal memory of the player 24 corresponding to the title of the disk selected, etc.

In another alternative embodiment, the disks may be discarded completely and the player may be provided with additional buttons for selection of a given title. The internal memory of the player including a plurality of blocks for each title. As in the above embodiments, depression of the play button 50 causing the player 24 to play the first block of data associated with the selected title and each further depression of the play button 50 causing the player 24 to play the next block of data, etc.

As many apparently widely different embodiments of the present invention can be made without departing from the spirit and scope thereof, it is to be understood that the invention is not limited to the specific embodiments thereof except as defined in the appended claims.

What is claimed is:

1. A book comprising directions at multiple predetermined locations directing a reader to play at least a portion of data stored in a player, said player being configured to play stored data upon loading of a disk and activation by a user, the player and stored data being configured such that activation of the player plays one block of the stored data associated with the loaded disk and relevant to a portion of the book and activation of the player a subsequent time plays another block of the stored data associated with the loaded disk and relevant to another portion of the book, the player being configured to automatically stop playing at the end of each block of the stored data.

2. The book of claim 1, wherein the book further includes a front cover, a back cover, a binder portion connecting the front and back covers, and at least one page between the front and back covers, the at least one page including the directions.

3. The book of claim 1, wherein the book includes a story including a direction indicating when to load one of the one or more disks associated with the story into the player and one or more directions at various points in the story indicating when to activate the player so as to play blocks of stored data relating to specific portions of the story.

4. The book of claim 1, wherein each block of stored data corresponds to a musical piece.

5. The book of claim 1, wherein the player includes a memory unit including the stored data.

6. The book of claim 1, wherein the stored data includes sets of blocks, each of the one or more disks being associated with a different set.

7. The book of claim 6, wherein each disk is configured to provide address information to the player for a different set of blocks, the player being configured to play the first block in a given set upon a first activation of the player and one additional block in the set for each subsequent activation.

8.The book of claim 1, wherein the player includes a play button configured to activate the player and trigger the playing of the stored data.

9.The book of claim 1, wherein the player includes a stop button for stopping the player.

10. The book of claim 1, wherein the player includes a cover biased in an open state, a latch for retaining the cover in a closed state, and an open button for releasing the latch.

11. The book of claim 1, wherein the player includes a loading surface and is configured such that a disk loaded in the player faces the loading surface, said loading surface including one or more buttons configured to one of mate with one or more recesses on a surface of the loaded disk facing the loading surface and be depressed by one or more ridges on the surface of the loaded disk facing the loading surface.

12. The book of claim 11, wherein the one or more ridges are circular.

13. The book of claim 11, wherein the player is configured such that one or more of the buttons in the loading surface are depressed by the loaded disk.

14. The book of claim 11, wherein the player is configured such that one or more of the buttons in the loading surface fits into the one or more recesses in the loaded disk and are not depressed by said loaded disk.

15. The book of claim 11, wherein the player includes a play button configured to activate the player and trigger the playing of the stored data and wherein upon depression of the play button the player determines which set of blocks to access based on which buttons on the loading surface are depressed.

16. The book of claim 6, wherein each set is associated with at least one of a different story in the book and indicia on a different disk.

17. The book of claim 1, wherein each of the one or more disks include indicia associated with the story in which the directions directing the reader to activate the player are included.

18. The book of claim 2, wherein the back cover includes an overhang portion which extends beyond an edge of the front cover and supports the player and one or more of the disks.

19. The book of claim 18, further comprising a disk storage unit connected to the overhang portion for storage of the one or more disks.

20. The book of claim 1, wherein the player is configured to be removably connectable to the book.

21. The book of claim 18., wherein the player is connected to the overhang portion.

22. The book of claim 1, wherein the player further comprises a handle.

23. A book including a front cover, a back cover, a binder portion connecting the front and back covers, and at least one page including at least one story between the front and back covers, the back cover including an overhang portion which extends beyond an edge of the front cover and supports a player, the player being configured to play stored data upon activation by a user, wherein the at least one story includes one or more directions at various points in the at least one story indicating when to activate the player so as to play blocks of stored data associated with specific portions of the at least one story.

24. The book of claim 23, wherein the stored data comprises sets of blocks of the stored data, each set being associated with a different story in the book.

25. The book of claim 23, wherein the stored data includes blocks and the player is configured to automatically stop playing at the end of each block.

26. The book of claim 23, wherein the overhang portion further supports one or more disks for loading into the player.

27. The book of claim 26, wherein the at least one story further includes directions indicating which of the one or more disks to insert into the player and when to make this insertion.

28. The book of claim 24, wherein the player further comprises an identification means for identifying which set of blocks of the stored data to access upon activation of the player.
